(19) United States
(12) Patent Application Publication
(10) Pub. No.: US 2015/0062369 A1
(43) Pub. Date: Mar. 5, 2015

(54) Optoelectronic Apparatus and Method for Recording Rectified Images

(71) Applicant: SICK AG, Waldkirch (DE)

(72) Inventors: Roland GEHRING, Waldkirch (DE); Stephan WALTER, Waldkirch (DE); Dennis LIPSCHINSKI, Waldkirch (DE)

(21) Appl. No.: 14/467,435

(22) Filed: Aug. 25, 2014

(30) Foreign Application Priority Data
Aug. 29, 2013 (EP) 13 182 134.0
Dec. 19, 2013 (EP) 13 198 333.0

(51) Int. Cl. H04N 5/232

(52) U.S. Cl. CPC H04N 5/23229
USPC 348/222.1

(57) ABSTRACT

An optoelectronic apparatus (10), in particular a camera-based code reader for the recording of rectified images is provided, comprising an image sensor (18) which records a source image from a monitored zone (12) and comprising a digital component (20), in particular an FPGA, which processes the source image. In this connection transformation parameters for the rectification of the source image (22) are stored in the digital component (20) and a transformation unit (24) is implemented at the digital component (20), with the transformation unit dynamically calculating a rectified image from the source image with reference to the transformation parameters.

The invention relates to an optoelectronic apparatus and to rectifying a method for the recording of rectified images in accordance with the preamble of claim 1 or claim 18, respectively.

In industrial applications, cameras are used in a plethora of ways in order to automatically detect object properties, for example, for the inspection of objects or for the measurement of objects. In this connection images of the object are recorded and are evaluated in accordance with the task by image processing methods. A further application of cameras is the reading of codes. Such camera-based code readers are taking over from the still widely disseminated bar code scanners. With the aid of an image sensor objects having the codes present thereon are recorded, the code regions are identified in the images and then decoded. Camera-based code readers can easily also manage other code types rather than only onedimensional bar codes, the other code types being structured like a matrix code also in two dimensions and make available more information.

A frequent situation of detection is the assembly of the camera above a conveyor belt, where further processing steps are induced in dependence on the accrued object properties. Such processing steps, for example, comprise the processing adapted to the specific object at a machine which interacts with the conveyed objects or in a change of the object flow, in that certain objects are excluded from the object flow in the frame work of a quality control, or the object flow is sorted into a plurality of part object flows.

Having regard to the image evaluation, additional problems arise due to the fact that the images are not usually recorded under ideal conditions. Besides an insufficient illumination of the objects, which can be avoided by corresponding illumination units, image errors arise, in particular because of an unfavorable perspective of the camera with respect to the recorded object surface and through errors of the optics.

Having regard to uncorrected images additional methods for the improvement of the robustness have to be used in dependence on image errors or distortions in algorithms, such as for bar code recognition, inspection or text recognition (OCR). In this connection frequently important parameters and information is missing at this point on how these image errors have arisen so that a correction is made more difficult or impossible. Furthermore, such algorithm specific measures lead to an incredible increase in demand in effort and cost.

It is known in the state of the art to carry out image corrections with the aid of software. For this purpose lookup tables (LUT) are calculated which correct the perspective distortion and the lens distortion for a fixed camera arrangement or a determined objective respectively.

In order to quickly process the large amount of data which typically arises during the image detection and, if possible, in real time specialized additional components, such as FPGAs (Field Programmable Gate Arrays), are used in camera applications. It is also possible to carry out a rectification in this way in that reference is made to correspondingly prepared lookup tables. However, such a lookup table requires rectification information for each pixel and in this way requires very considerable memory resources which are not available at an FPGA for common image resolutions of a camera. For this reason an external memory has to be provided. Moreover, lookup tables are very inflexible: Possible changes of the recording situation have to be anticipated in order to calculate corresponding lookup tables in advance. The in any way considerable demand in memory for only one lookup table is multiplied in this connection. Moreover, depending on the memory architecture, the switching between two lookup tables can take up a considerable amount of time.

For this reason, it is the object of the invention to improve the image rectification.

This object is satisfied by an optoelectronic apparatus and by a method for the recording of rectified images in accordance with claim 1 or claim 18 respectively. In this connection the invention is based on the underlying idea of carrying out the rectification of the recorded images dynamically and in real time or in quasi real time with reference to transformation parameters at a digital component suitable for a large data throughput, in particular an FPGA. In contrast to a common lookup table which includes a calculation for each image point or pixel of the image sensor, only very few transformation parameters are sufficient, whose memory demand is negligible. Thereby, an external memory for lookup tables can be omitted. An external memory would not only cause costs and demand in effort for the connection to the digital components, but would also limit the processing time of the transformation through the required external memory accesses and in this way would limit the real time capabilities.

When the recording situation changes, for example due to a change of the camera position, due to a change of the objective or also merely due to newly recorded objects present in the scene, it is sufficient to adapt the transformation parameters. The image rectification can take place directly at the source, this means directly during the image detection, and/or on the reading from the image sensor. Each subsequent image processing, such as a bar code recognition, inspection, text recognition or image compression (e.g. JPEG), then already works with rectified images and thereby becomes more robust and more exact without particular measures.

The invention has the advantage that a very flexible, efficient and resource-saving image rectification is enabled at the digital component. Since the images are rectified directly at the start of the processing chain, the performance of the camera and, in particular the detection rate or reading rate of a code reader or of a text recognition system is improved. The high possible processing speed also means that a continual image flow can be rectified.

The transformation parameters preferably comprise parameters for a perspective correction and/or a distortion correction. The perspective correction considers the position of the image sensor with regard to a recorded object surface and a consideration of the camera parameters. Distortion in this connection generally means the generic term for object errors and specifically a lens distortion. The two corrections can be carried out one after the other, for example, first a perspective correction and subsequently a distortion correction. However, it is also possible to cascade a plurality of such corrections. For example, a first set of transformation parameters serves the purpose of compensating lens errors in a camera and positioning tolerances of the image sensors in advance and a second set of transformation parameters corrects the perspective of the camera with respect to the object during the recording.

Preferably the transformation parameters comprise a rotation, a translation, an image width and/or a shift of the image sensor with respect to the optical axis for the perspective correction. Through rotation and translation it can be ensured that the rectified image corresponds to an ideal, centrally aligned and vertical camera position with respect to the object and the object surface to be recorded is thus centrally aligned and can be illustrated at a specific resolution or in a format filling manner as required. Also camera parameters, in particular the image width which is stated in two vertical directions for non-quadratic pixels and a shift between the optical axis and the origin of the pixel matrix of the image sensor are also included in this perspective transformation.

The transformation parameters for the distortion correction preferably comprise at least first and second radial distortion coefficients. A pixel can be radially and tangentially displaced by the lens distortion. Practically it is frequently sufficient to correct the radial distortion, since this dominates the effect. The correction is approximated by a Taylor expansion whose coefficients are a possible configuration of the distortion coefficients. The higher orders of distortion coefficients can then be neglected at least for high quality objectives.

The apparatus preferably comprises a calibration unit in order to determine the transformation parameters with reference to a recorded calibration target. Thereby arbitrary additional recording situations can be taught without specific special knowledge. The calibration unit is preferably implemented at an additional component, such as a microprocessor, since relatively complex calculations are required in this example having regard to which, for example, an FPGA is not configured. Since the teaching takes place outside of the actual recording mode of operation, the calibration unit can also be an external computer. Through the calibration, the apparatus, in particular knows its own position and orientation relative to the calibration target or a reference position or a reference plane determined therefrom, respectively.

The transformation parameters can preferably be changed between two recordings of the image sensor. The flexibility is a large advantage of the invention, since merely the few transformation parameters have to be changed in order to carry out a rectification for a changed recording situation, with the change being possible without further ado dynamically or on the fly. The rectification is thus tracked when the recording conditions, such as focal position, spacing between camera and object, orientation of the camera and/or of the object, regions of interest (ROI), geometry of the object, used lens region, illumination or temperature change.

The apparatus preferably has an objective having a focus adjustment, wherein, following a focus adjustment, the transformation unit uses transformation parameters adapted thereto. In this way a dynamic image rectification also for focus adjustable systems or autofocus systems is possible.

The transformation parameters can preferably be changed during the rectification of the same source image. Then, different image regions are rectified in different manners. For example, having regard to a real time rectification during the reading of image data from the image sensor, the transformation parameters are changed between two pixels. In this example, the dynamic achieves an even more sophisticated stage which could not be carried out by means of a lookup table independent of the demand in effort and cost used.

For a plurality of regions of interest the transformation unit preferably uses various transformation parameters within the source image. This is an example for a dynamic switching of the transformation parameters during the rectification of the same image. For example, side surfaces of an object of the same source image having a position and orientation different with respect to one another can be transformed into a vertical top view. Thereby, for example, codes or texts become more readable and can be processed with the same decoder without having to consider the perspective.

The transformation parameters can preferably be changed in that a plurality of sets of transformation parameters are stored in the digital component and a change can be made between these sets. This is not to be confused with the common preparation of a plurality of lookup tables which require more calculation demand and more memory demand by many orders of magnitude. In this case merely the few transformation parameters are respectively stored for different recording situations. This is sensible in those cases when the change cannot be stated in a complete form. For example, no complete calculation method is currently known as to how the transformation parameters behave for a changed focal position so that this calculation could be replaced by a teaching process.

The transformation unit preferably interpolates an image point of the rectified image from a plurality of adjacent image points of the source image. When a virtual corresponding image point is determined in the source image for an image point of the rectified image, this generally does not lie within the pixel grid. For this reason, the neighborhood of the virtually corresponding image point in the source image is assumed for the grey scales or the color scales of the image point in the rectified image and is weighted with regard to the spacing of the virtually corresponding image point with respect to the adjacent actual image points of the source image or the pixels of the image sensor respectively.

The transformation unit preferably uses floating point calculations in a DSP core of the digital component configured as an FPGA for the accelerated real time rectification. An FPGA is suited to quickly carry out simple calculations for large amounts of data. Complicated calculation steps, such as floating point operations are indeed also implementable, however, are typically avoided due to the large demand in effort and cost. Through the utilization of the DSP core (digital signal processing) which is provided in FPGAs of the newest generation, floating point operations can also be carried out at the FPGA in a simple manner.

The transformation unit preferably has a pipeline structure which outputs image points of the rectified image from the image sensor, in particular in time with the reading of image points of the source image. The pipeline for example comprises a buffer for image points of the source image, a perspective transformation, a distortion correction and an interpolation. The pipeline initially buffers as much image data as is required for the calculation of the first image point of the rectified image. Following this transient process in which this buffer and the further stages of the pipeline have been filled, the image points of the rectified images are output in time with the reading. Apart from a small delay in time through the transient process, the already rectified image is in this way provided just as fast as the distorted source image without the invention.

The apparatus preferably has a plurality of image sensors which each generate a source image from which the transformation unit calculates a rectified image, wherein an image stitching unit is configured for the purpose of stitching the rectified images to a common image. The transformation parameters for the image sensors preferably differ between one another in order to compensate their different perspectives, camera parameters and distortion. In this connection, an own transformation unit can be provided for each image sensor, but also a common transformation unit can process the individual images with the different sets of transformation parameters one after the other. The stitching of the images is then based on rectified images which are, in particular provided with the same resolution, and for this reason leads to significantly improved results. The apparatus outwardly behaves like a single camera with an enlarged viewing range and the structure of the apparatus having a plurality of the image sensors does not have to be considered from the outside. The image stitching can, however, also take place externally. It is also plausible that the source images of the individual image sensors can be transmitted uncorrected and can each be forwarded with a set of transformation parameters to a central evaluation unit which then carries out the rectification and possibly the image stitching camera-specifically.

The method in accordance with the invention can be furthered in a similar manner and in this connection shows similar advantages. Such advantageous features are described by way of example, but not conclusively in the dependent claims adjoining the independent claims.

The invention will be described in detail in the following also with regard to further features and advantages by way of example by means of embodiments and with reference to the submitted drawing. The images of the drawing show in:

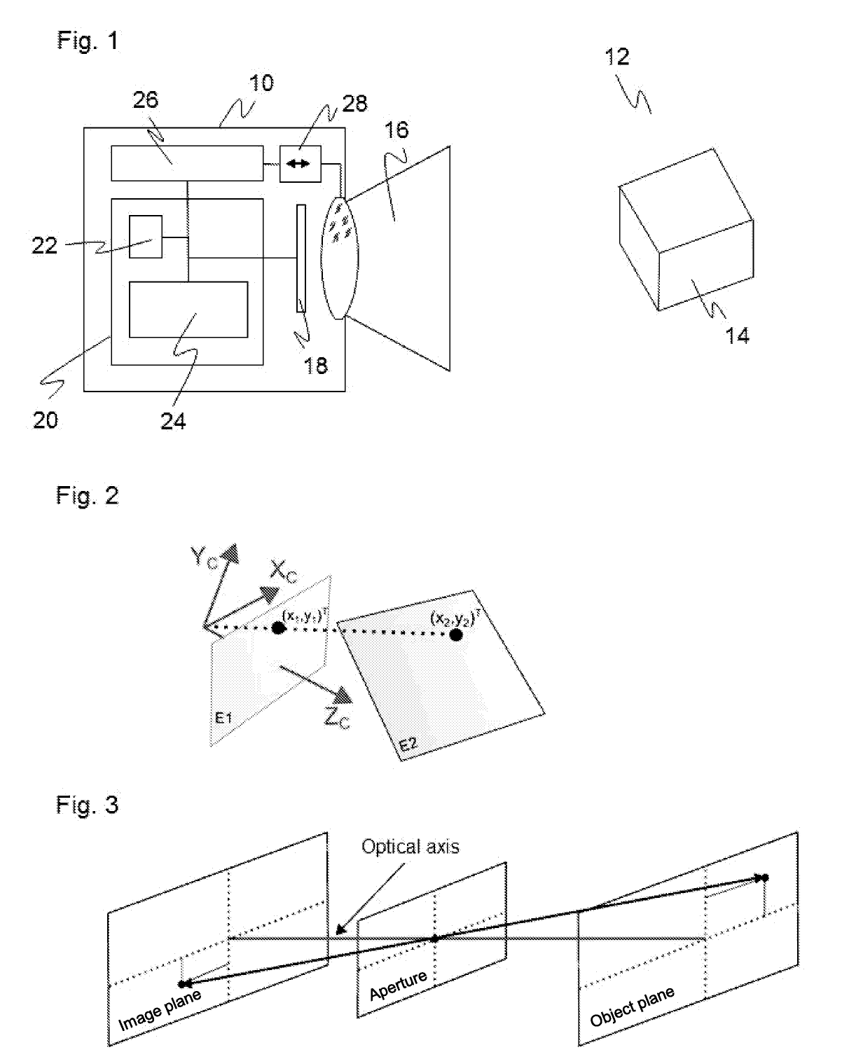

FIG. 1 a block illustration of a camera for the recording of rectified images;

FIG. 2 an illustration of the images of a point of an object plane at the image sensor plane by means of central projection;

FIG. 3 an illustration of a pin hole camera model;

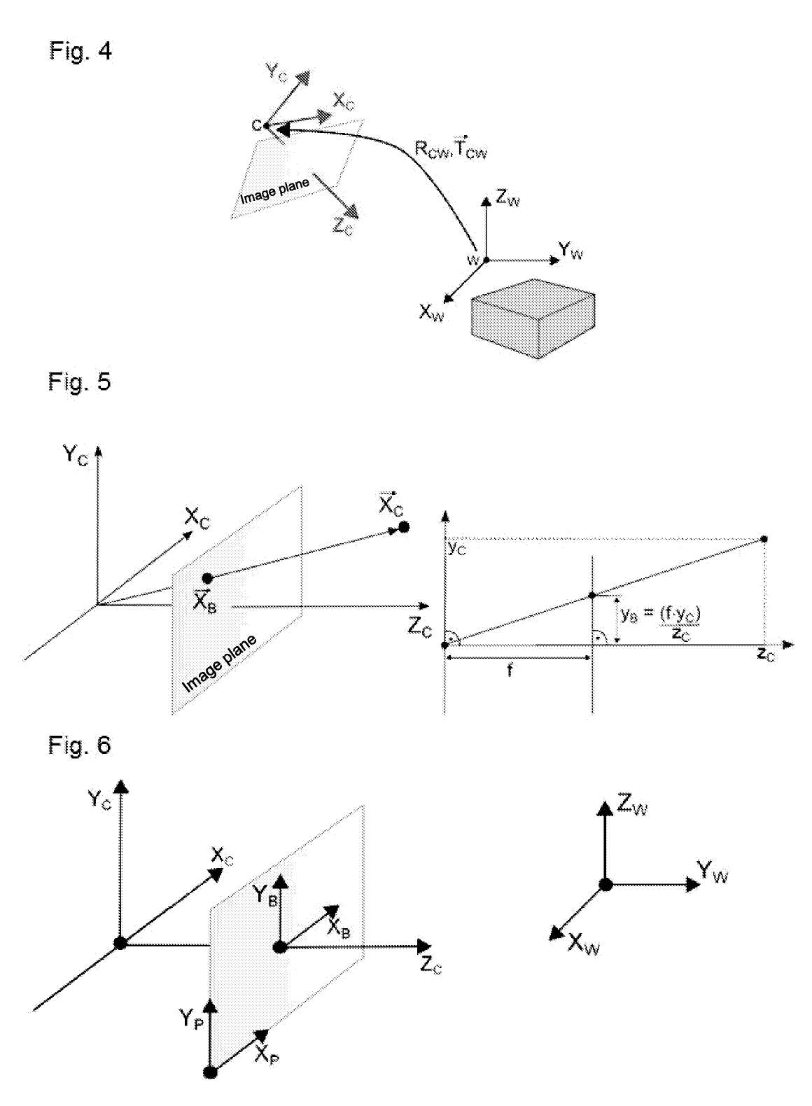

FIG. 4 an illustration of the rotation and translation from a world coordinate system into a camera coordinate system;

FIG. 5 an illustration with regard to the projection of a point in a camera coordinate system at the image sensor plane;

FIG. 6 an illustration of the four related coordinate systems;

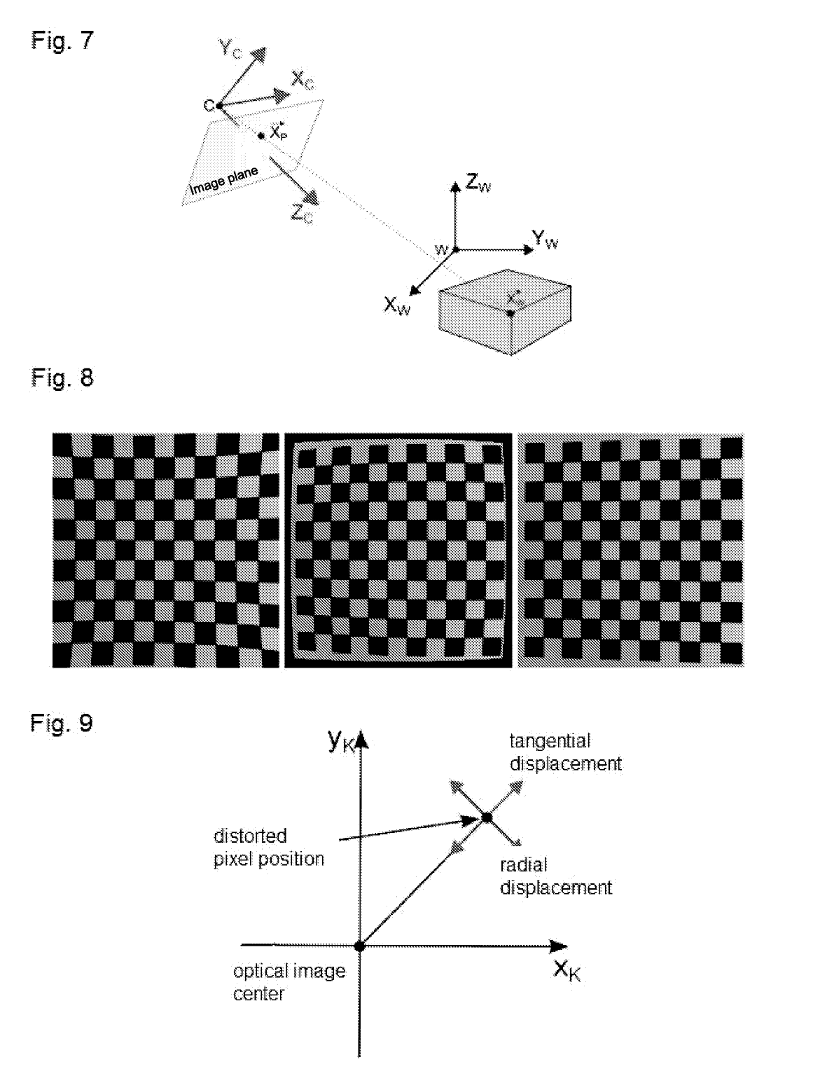

FIG. 7 an illustration of the projection of a point in the world coordinate system onto the pixel coordinate system;

FIG. 8 an exemplary illustration of a cushion-like distortion, a drum-like distortion and a corrected image;

FIG. 9 an illustration of the effect of the distortion as a tangential and radial displacement of the image points;

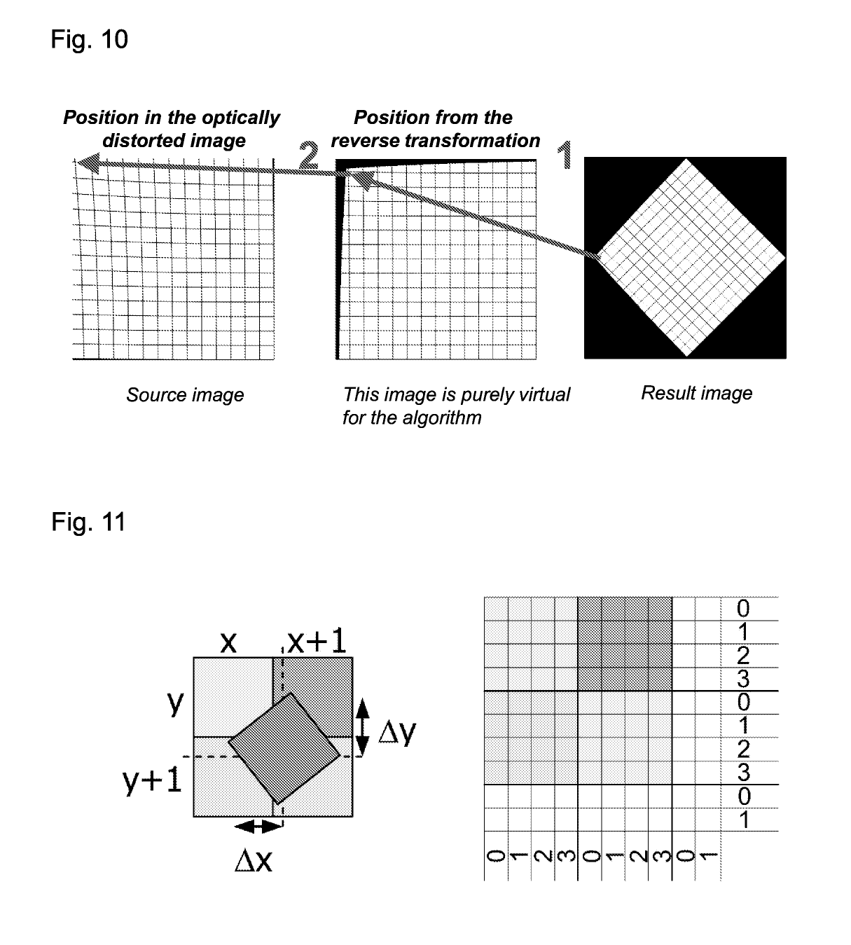

FIG. 10 an illustration as to how an image is geometrically and optically rectified in two steps;

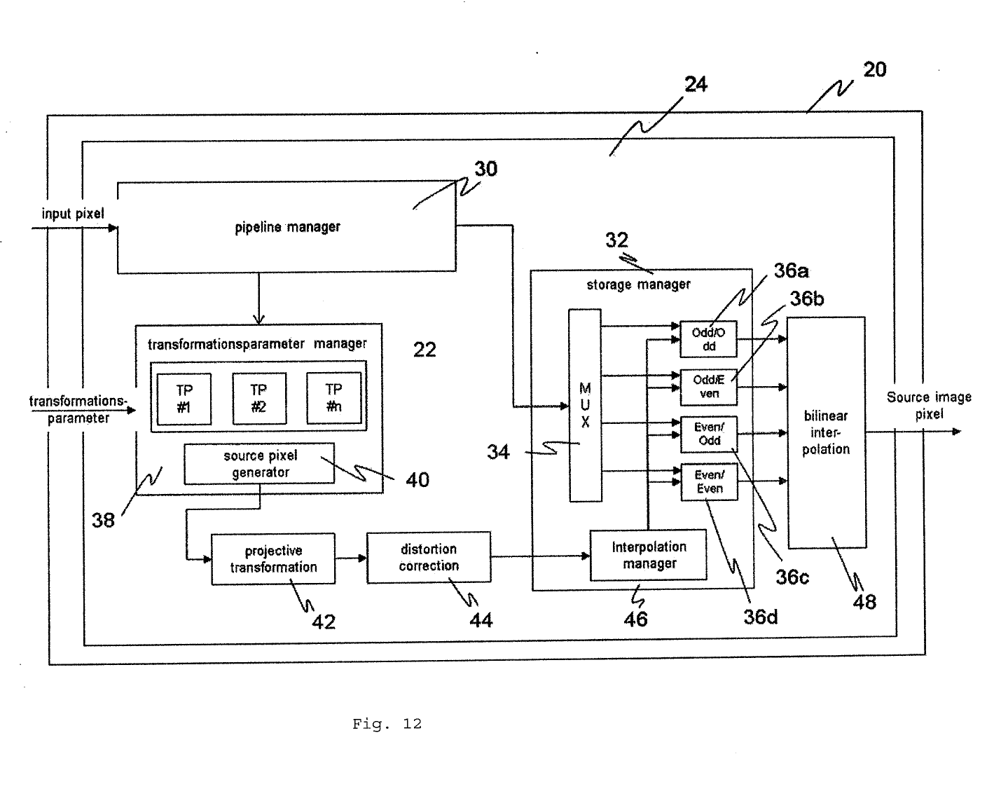

FIG. 11 an illustration for the explanation of the calculation of weighting factors for a bilinear interpolation;

FIG. 12 a block diagram of an exemplary implementation of a transformation unit as a pipeline structure;

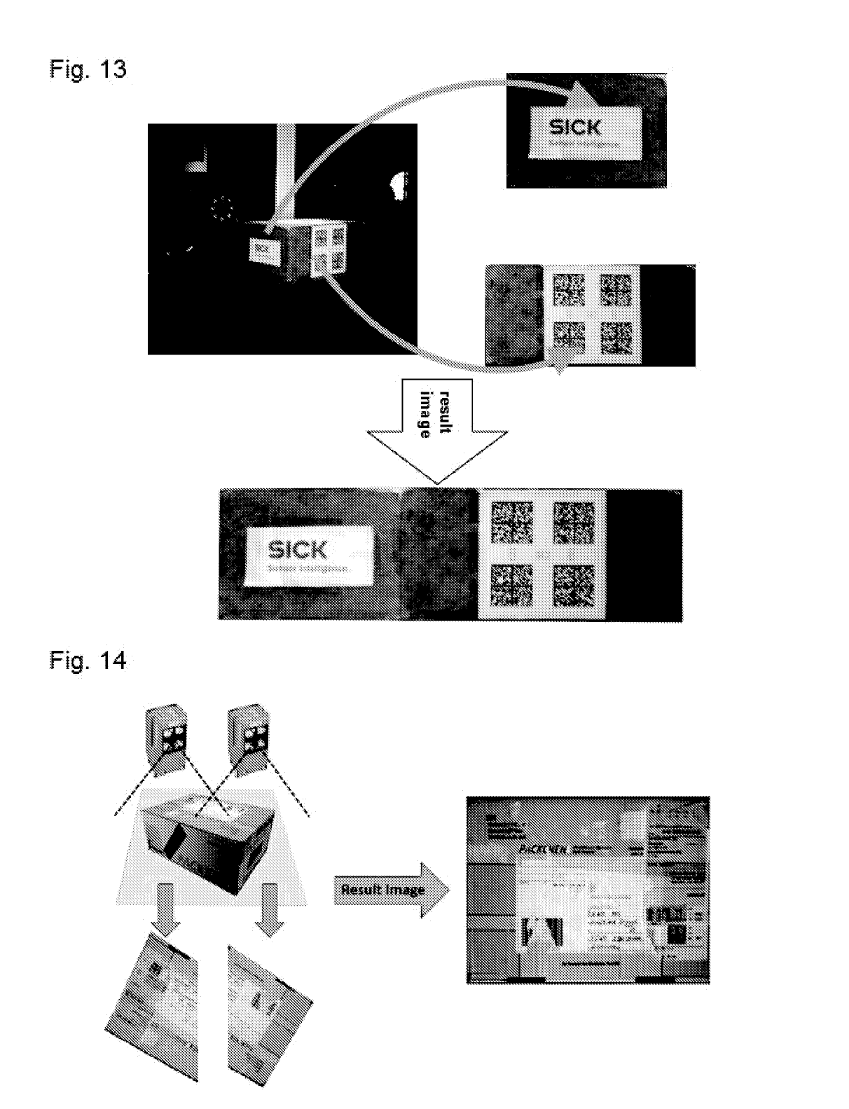

FIG. 13 a case of application with different transformations for different side surfaces of an object;

FIG. 14 a further case of application in which two views of an object surface lying next to one another are initially rectified and then stitched; and

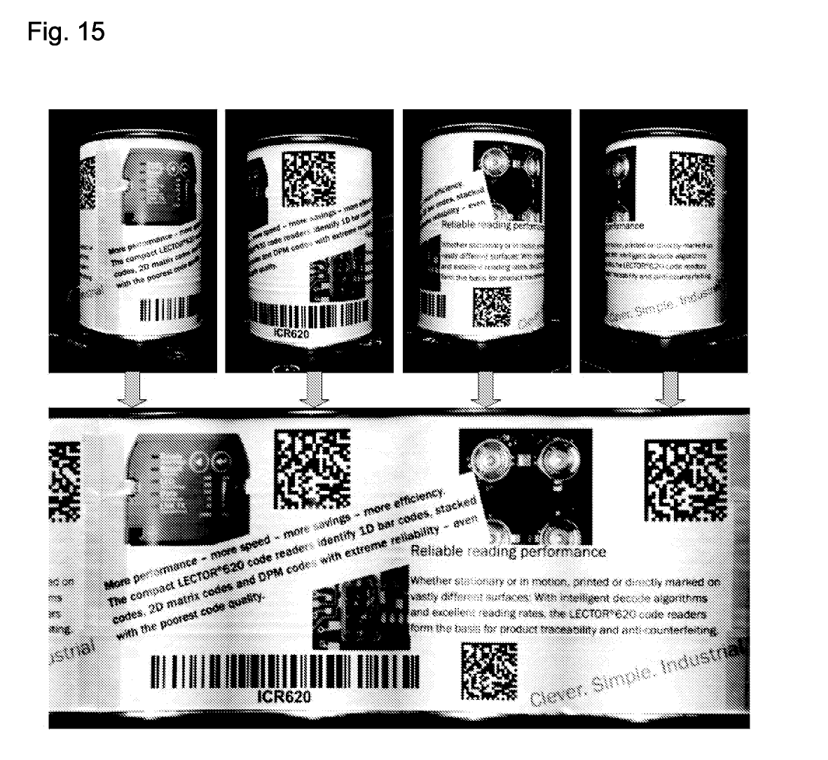

FIG. 15 a further case of application in which a cylindrical object is recorded from a plurality of sides in order to stitch the complete jacket surface from the rectified individual recording.

FIG. 1 shows a block illustration of an optoelectronic apparatus, respectively a camera 10, which records and rectifies a source image from a monitoring zone 12 having a scene illustrated by an object 14. The camera 10 has an objective 16 of which only one lens is shown in a manner representative for all types of objectives. Moreover, the received light from the monitored zone 12 is guided to an image sensor 18, for example, a matrix or line-shaped recording chip based on the CCD technology or CMOS technology.

A digital component 20, preferably an FPGA or a comparable programmable logic component is connected to the image sensor 16 for the evaluation of the image data. A memory 22 for transformation parameters, as well as a transformation unit 24 are provided at the digital component 20 in order to rectify the image data. The digital component 20 can also satisfy the further evaluation and control tasks of the camera 10. In the exemplary embodiment in accordance with FIG. 1 the digital component 20 is supported for this purpose by a microprocessor 26. Whose functions also comprise the control of a focus adjustment unit 28 for the objective 16.

The underlying idea of the invention is the image rectification at the digital component 20 by means of the transformation unit 24. The remaining features of the camera 10 can be varied in accordance with the customs according to the state of the art. Correspondingly, it is also not limited to a camera type and the invention relates to, for example, monochromatic cameras and colored cameras, line cameras and matrix cameras, thermal cameras, 2.5D cameras working in accordance with the light section process, 3D cameras working in accordance with the stereo process or with the time of flight of light process and more. The image correction for example comprises geometric and optical distortions in dependence on varying input parameters, such as arrangement and orientation of camera 10 with respect to object 14, regions of interest (ROI) in the image section, focal position, objective properties and objective errors, as well as of required result parameters, such as image resolution or target perspective. The transformation unit 24 rectifies the source image received from the image sensor 18, preferably as early as possible, this means directly at the source, quasi as a first step of the image evaluation, so that all downstream algorithms, such as, object recognition, object tracking, identification, inspection, code reading or text recognition can already work with rectified images and in this way can become more exact and generate less demand in processing.

In order to understand the working principle of the transformation unit 24 a few mathematical foundations will initially be stated with reference to the FIGS. 2 to 9. These foundations are then applied in a supported manner in the FIGS. 10 and 11 as illustrated for an embodiment of the image rectification. Subsequently, an exemplary pipeline structure for the transformation unit 24 in a digital component 20 configured as an FPGA will be explained with reference to the FIG. 12, before finally a few cases of application will be presented in accordance with FIGS. 13 to 15.

Two particularly important image corrections of the transformation unit 24 are the perspective rectification and the distortion by the objective 16. Initially the perspective rectification is considered by means of which a plane of the object 14 in the monitored zone object region should be transformed to the plane of the image sensor 18. A rotation with three parameters of rotation, as well as a displacement with three parameters of translation are generally required for this purpose. In addition to this, camera parameters which consider the imaging by the objective 16, as well as properties and position of the image sensor 18 within the camera 10 are considered.

In order to represent the rotation and translation by a single matrix operation, a transformation in the affine space is considered in which the position coordinates q ε [symbol] ⁿ of the euclidic space are expanded by one dimension through the addition of a homogeneous coordinate, wherein the homogeneous coordinate includes the value 1:

q=(q₁, . . . ,qₙ,1).

The homogeneous coordinate now as desired enables the linear transformation with a matrix of rotation R_{CW} and a translation vector T_{CW} which translate the position vectors ^{e}X_{C}, ^{e}X_{W} of the camera (C) and of the world (W) in the euclidic space into one another, by

^{e}X_{C}=R_{CW}^{e}X_{W}+T_{CW}

which can be represented as a closed matrix multiplication as:

$${X}_{C} = ( \begin{matrix}{R}_{CW} & {T}_{CW} \\ 0 & 1\end{matrix} ) {X}_{W} = ( \begin{matrix}{r}_{11} & … & {r}_{1 n} & {t}_{1} \\ ⋮ & ⋱ & ⋮ & ⋮ \\ {r}_{n 1} & … & {r}_{nn} & {t}_{n} \\ 0 & 0 & 0 & 1\end{matrix} ) ( \begin{matrix}{x}_{w 1} \\ ⋮ \\ {x}_{wn} \\ 1\end{matrix} )$$

in that the position vectors ₑX_{C}, ^{e}X_{W} are expressed as X_{C},X_{W} in homogeneous coordinates.

The homogeneous coordinates are suitable for the description of the imaging process of the camera 10 as a central projection. FIG. 2 illustrates this for a point (x₂, y₂)^{T} of the plane E₂ in the object region which is imaged onto a point (x₁,y₁)^{T} in the plane E₁ of the image sensor 18. In this respect the homogeneous coordinate xₙ₊₁≠1, as it corresponds to a scaling factor which translates a vector in the projective space by

$${x}_{m} = \frac{{\breve{x}}_{m}}{{x}_{n + 1}} für alle m ∈ \{ 1 , … , n \}$$

through the normalization with the homogeneous coordinate xₙ₊₁ into a corresponding vector in the affine subspace. A projective transformation, also referred to as a homographic transformation, can be expressed as a matrix multiplication of the homogeneous vectors \check{x}₁, \check{x}₂ having the homographic matrix H. Through the normalization with the homogeneous coordinate wₙ the transformed plane is translated back from the projected space into the affine subspace:

$${\breve{x}}_{1} = H {\breve{x}}_{2} , \\ ( \begin{matrix}{x}_{1} \\ {y}_{1} \\ {w}_{1}\end{matrix} ) = ( \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ) ( \begin{matrix}{x}_{2} \\ {y}_{2} \\ 1\end{matrix} ) .$$

The image of the camera 10 should be detected with a model which describes all essential properties of the camera 10 with as few parameters as possible. For this purpose the pin hole camera model is duly sufficient which is illustrated in FIG. 3. In this connection the image points of the object plane experiences a point mirroring at the focal point on a projection of the world scene and are thereby imaged as a mirror image at the image plane.

In order to now calculate the projection of arbitrary 3D world points X_{W} at the image plane, the rotation R_{CW} and the translation T_{CW} from the world coordinate system W into the camera coordinate system C is required in the first step. This is illustrated in FIG. 4.

In order to simplify the description of the central projection the image plane is now placed in front of the focal point and the focal point is placed into the coordinate origin C of the camera 10 as is illustrated in the left part of FIG. 5. The coordinate origin C corresponds to the image side focal point of the objective 16. The camera main axis Z_{C} cuts the image plane orthogonally in the optical image center point of the image P. The projection is then calculated via the radiation formulae in accordance with the right part of the FIG. 5, wherein the point of incidence of the projection is determined via the spacing f or the image width, respectively.

For a complete consideration, an image coordinate system B and a pixel coordinate system P are now additionally introduced. All used coordinate systems are shown in FIG. 6. The image coordinate system is purely virtual and is useful because of its rotational symmetry for the calculation of distortion coefficients still to be described. The pixel coordinate system is the target coordinate system in which the projection of an arbitrary world point onto the pixel plane should be described.

The perspective projection of a world point X_{W} in the image coordinate system B is calculated by a rotation and a translation into the camera coordinate system C by

X_{C}=(x_{C},y_{C},z_{C})=R_{CW}X_{W}+T_{CW}

with a subsequent projection onto the image coordinate x_{B}, y_{B}:

$${x}_{B} = \frac{{fx}_{C}}{{z}_{C}} , {y}_{B} = \frac{{fy}_{C}}{{z}_{C}} .$$

Expressed as a matrix this results in

$${\breve{x}}_{B} = ( \begin{matrix}{fx}_{C} \\ {fy}_{C} \\ {z}_{C}\end{matrix} ) = ( \begin{matrix}f & 0 & 0 \\ 0 & f & 0 \\ 0 & 0 & 1\end{matrix} ) ( \begin{matrix}{x}_{C} \\ {y}_{C} \\ {z}_{C}\end{matrix} ) .$$

Since it is a perspective projection, this equation must still be normalized with its homogeneous coordinate Z_{C}. Moreover, the origin of the pixel coordinate system typically lies disposed opposite the optical axis of the camera 10 displaced by a displacement vector (pₓ, p_{y}^{T}. For this reason

$$( \begin{matrix}{x}_{B} \\ {y}_{B} \\ 1\end{matrix} ) ( \begin{matrix}\frac{{fx}_{C} + {p}_{x}}{{z}_{c}} \\ \frac{{fy}_{C} + {p}_{y}}{{z}_{c}} \\ \frac{{z}_{C}}{{z}_{C}}\end{matrix} ) = ( \begin{matrix}f & 0 & {p}_{x} \\ 0 & f & {p}_{y} \\ 0 & 0 & 0\end{matrix} ) ( \begin{matrix}{x}_{C} \\ {y}_{C} \\ {z}_{C}\end{matrix} ) .$$

is true.

Now, camera-specific properties are still considered. The pixels of the image sensor 18 can have a different size in the x- and y-directions which changes the image width f and the displacement vector (pₓ, p_{y}^{T}) by the scaling factors sₓ,s_{y}:

fₓ:=sₓf,

f_{y}:=s_{y}f,

x₀:=sₓpₓ,

y₀:=s_{y}p_{y},

Furthermore it is still plausible that the two axes of the image sensor 18 are not orthogonal to one another. This is considered in a skew parameter s which is however typically negligible for common cameras 10. The five camera parameters are recorded in a matrix

$$K := ( \begin{matrix}{f}_{x} & s & {x}_{0} \\ 0 & {f}_{y} & {y}_{0} \\ 0 & 0 & 1\end{matrix} ) .$$

Together with the respective three degrees of freedom of the rotation R_{CW} and the translation T_{CW}, the transformation is described by 11 parameters and in conclusion it is true that the projection X_{P} of an arbitrary point X_{W} in the world coordinate system into the pixel coordinate system can be calculated by

X_{P}=K(R_{CW}XW+T_{CW}).

This transformation is illustrated again in FIG. 7.

Following this consideration of the perspective rectification a distortion correction is now explained. FIG. 8 as an example in the left part shows a cushion-like distortion, in the central part a drum-like distortion and in the right part the striven for corrected image. Through a lens distortion straight lines of the object region are imaged in a curved manner at the image sensor 18. The lens distortion amongst other things depends on the quality of the objective 16 and its focal length. Considered for a single image point, the distortion, as is shown in FIG. 9, brings about a radial and tangential displacement. The distortion is radially symmetric and its magnitude depends from a spacing r_{d}=\sqrt{x_{K}²+y_{K}²} with respect to the center of the distortion. Instead of the precise calculation over the square, a Taylor expansion is typically carried out in which only the first terms of the Taylor coefficients described as distortion coefficients are considered. Moreover, it is known that the radial distortion dominates the tangential distortion so that frequently a sufficient accuracy is achieved when one only considers the second and the fourth order of two distortion coefficients k₁, K₂. Having regard to the correction function which images a non-distorted image point x_{Ku}=(x_{Ku}, y_{Ku})^{T} of the current pixel position x_{K}=(x_{K}, y_{K})^{T} at the image sensor 18 the following is then true

x_{Ku}=xₖ(1+k₁r_{d}²+k₂r_{d}⁴).

FIG. 10 illustrates how a source image of the image sensor is geometrically and optically rectified in two steps. In a first backward transformation the still distorted position is calculated with an inverse homographic matrix by a so-called shift vector. In a second transformation the non-distorted pixel position is calculated which corresponds to a modification of the shift vector.

The therefore required transformation parameters are stored in the memory 22. An example for a set of transformation parameters are the above-mentioned degrees of freedom of rotation and translation, the camera parameters and the distortion coefficients. Not all of these transformation parameters have to necessarily be considered and vice versa further parameters can still be added, for example, in that the overall homographic matrix is predefined with its eight degrees of freedom, parameters for a rectangular image section which ensure an image section without a black boundary, or further distortion coefficients.

The camera 10 can have an optional calibration mode in which the transformation parameters are taught. For example, in this connection the geometry of the scene can be received by a different sensor, for example, by a distance-resolving laser scanner. The own position can be determined and adjusted by the camera via a position sensor. Also methods are known with which the perspective, the camera parameters and/or the distortion from two or three-dimensional calibration targets can be estimated. Such a calibration target, for example a grid model can be projected itself also by the camera 10 which enables a quick automatic tracking of transformation parameters.

Calculations which have to be carried out infrequently, in particular when they include complex calculation steps, such as the estimation of transformation parameters are preferably not implemented at an FPGA, since this requires too large a demand in effort and cost and consumes resources of the FPGA. For this purpose, the microprocessor 26 is rather used or even an external computer is rather used.

A further example for such a seldomly required calculation is the forward transformation \vec{ROI}ₜ of a region of interest \vec{ROI} which is, for example, determined for the specific case of application of a rectangular region by the edge positions. Moreover, further plausible transformation parameters are determined, namely the size and position of a region of interest of the image to which a geometric rectification should refer to:

$$\vec{ROI} = {( {y}_{1} , {y}_{2} , {x}_{1} , {x}_{2} )}^{T}$$

$$\vec{{ROI}_{t}} = {H ( \begin{matrix}{x}_{1} & {x}_{2} & {x}_{2} & {x}_{1} \\ {y}_{1} & {y}_{1} & {y}_{2} & {y}_{2} \\ 1 & 1 & 1 & 1\end{matrix} )}^{T} .$$

After normalization of the homogeneous coordinates of \vec{ROIₜ} the size of the result image and the offset vector are calculated:

N_{columns}=max(\vec{ROI}ₜ_{ₓ})−min(\vec{ROI}ₜ_{ₓ})+1,

Nₗᵢₙₑₛ=max(\vec{ROI}ₜ_{_{y}})−min(\vec{ROI}ₜ_{_{y}})+1,

Offsetₓ=min(\vec{ROI}ₜ_{ₓ})−1,

Offset_{y}=min(\vec{ROI}ₜ_{_{y}})−1,

If all transformation parameters are known then only the pixels, possibly limited to an ROI of the image size N_{columns}×Nₗᵢₙₑₛ, are subjected to the transformations. The subsequent calculation steps must thus be carried out very frequently for the plurality of pixels, for which purpose the digital component 20 and, in particular an FPGA, is suitable.

Before the projective (backward) transformation, the pixels (i,j) are corrected by the offset vector of the ROI:

$$( \begin{matrix}{x}_{1} \\ {x}_{2}\end{matrix} ) \begin{matrix}= \\ =\end{matrix} ( \begin{matrix}i + {Offset}_{x} \\ j + {Offset}_{y}\end{matrix} ) .$$

Subsequently, the projective transformation takes place with the inverse homographic matrix H⁻¹ by

$$x = ( \begin{matrix}{x}^{′} \\ {y}^{′} \\ {z}^{′}\end{matrix} ) = {H}^{- 1} ( \begin{matrix}{x}_{1} \\ {x}_{2} \\ 1\end{matrix} ) ,$$

whereupon the coordinates are still normalized with their homogeneous coordinates z′:

$$x = \frac{{x}^{′}}{{z}^{′}} , \\ y = \frac{{y}^{′}}{{z}^{′}} .$$

In order to correct the lens distortion the calculated pixel positions are translated into quasi camera coordinates:

$${X}_{C} = \frac{( {x}^{′} - {x}_{0}^{′} )}{{f}_{x}^{′}} , \\ {y}_{C} = \frac{y - {y}_{0}^{′}}{{f}_{y}^{′}} ,$$

wherein by way of example in this connection, an ideal camera matrix

$${K}^{′} = ( \begin{matrix}{f}_{x}^{′} & 0 & {x}_{0}^{′} \\ 0 & {f}_{y}^{′} & {y}_{0}^{′} \\ 0 & 0 & 1\end{matrix} )$$

in accordance with OpenCV [cf. G. Bradskys OpenCV Library] was used as an estimation of the camera matrix K

Via the distortion vector r_{d} emanating from the optical image center the distortion is then corrected as explained above in accordance with x_{Ku}=xₖ(1+k₁r_{d}²+k₂r_{d}⁴) and subsequently the pixel positions are again transformed into the pixel coordinate system with the camera matrix K.

In this way the position of origin of the non-distorted pixel is calculated in the result image. Since generally the calculated and non-distorted result pixel lies between four adjacent pixels, as illustrated in the left part of FIG. 4, the value of the result pixel per bilinear interpolation is determined. The normalized distance to each pixel in this connection corresponds to the weight with which each of the four source pixels should contribute to the result pixel.

The weighting factors K1 . . . K4 for the four source pixels are calculated with the four references in accordance with FIG. 1 to be

K1=(1−Δx)1−Δy),

K2=Δx(1−Δy),

K3=(1−Δx)Δy,

K4=ΔxΔy.

In this connection Δx, Δy are illustrated in a quantized manner in the right part of the FIG. 11, wherein the sub-pixel resolution amounts to 2 bits by way of example, in that case this means that a normalized step corresponds to 0.25 pixel.

FIG. 12 shows a block diagram of an exemplary implementation of the transformation unit 24 as a pipeline structure at a digital component 20 configured as an FPGA. In this way the image data can be rectified on the fly directly after the readout from the image sensor 18 in real time, in that the transformations, in particular shift vectors and interpolation weights, can be dynamically calculated. For this purpose merely the transformation parameters, which have no noteworthy memory requirement, are stored in contrast to common complete lookup tables having pre-calculated shift vectors and interpolation weights for each individual pixel of the image sensor for a predetermined situation. For this reason, an external memory can be omitted. The processing demand in effort and cost is controlled in real time through the implementation in accordance with the invention at the digital component 20. This enables a large flexibility in that merely the transformation parameters have to be changed in order to match these to a new situation. This can take place between two recordings, but even once or a multiple of times within the rectification of the same source image.

The transformation unit 24 has a pipeline manager 30 which receives the input pixels from the image sensor 18, for example directly after the serial transformation of parallel LVDS signals. The pipeline manager 30 forwards the input pixels to a memory manager 32, where a number of image lines predefined by the transformation are buffered in a divided manner according to straight and unstraight columns and lines via a multiplex element 34 into BRAM ODD/ODD 36a, BRAM ODD/EVEN 36b, BRAM EVEN/ODD 36c and BRAM EVEN/EVEN 34d. This kind of buffering thus enables that one input pixel is written at the same time as four pixels can be read from the block RAM memory 36. Thereby the transformation unit 24 is placed into the position of being able to process and to output pixels during the same clock pulse at which they were provided at the input side.

A transformation manager 38 which includes the memory 22 comprises one or more sets of transformation parameters TP#1 . . . TP#n from which a respective set is used for the rectification. However, the transformation parameters can likewise also be applied in a varying manner between two images or even within one image. As an alternative to the fixed sets of transformation parameters also a dynamic change of the transformation parameters would be plausible, for example, through the statement of functional associations or timely sequences.

If a sufficient amount of input pixels are intermediately stored then the pipeline manager 30 triggers the further blocks such that the transformation of the image can be started. For this purpose, the coordinates (i,j) of this rectified image currently to be processed are generated in a source pixel generator 40. As explained above in detail, a projective transformation 42 is initially applied to these coordinates (i,j), and subsequently a distortion correction 44 is applied in order to calculate the corresponding coordinates (i,j) in the source image.

Per clock pulse the memory manager 32 correspondingly receives a perspective backwardly transformed pixel position which is rectified from distortion errors from the source image. In this way an interpolation manager 46 simultaneously always makes reference to the four adjacent pixels of the received pixel position which are buffered in the block Ram memory 36. Moreover, the weighting factors K1 . . . K4 are calculated. The subsequent bilinear interpolation unit must merely correctly sort the received four adjacent pixels such that the weighting factors are correctly applied thereon. Then the source pixel of the rectified image is output at the position (i,j). Additionally, control commands, such as new image, new line or the like can be forwarded to downstream processing blocks.

The described structure can additionally still be expanded by additional dynamic corrections. For example, it is possible to carry out a brightness correction (flat field correction) on the basis of the calculated 2D image of a world scene in combination with a simplified illumination model. Other expansions are line-based correction values, anti-shading or fixed pattern noise. Such information can be directly calculated pixel-wise in parallel to the geometric transformation in the pipeline. The different corrections are then combined at the end of the pipeline.

A particularly preferred application of the switching from transformation parameter sets is the adaptation to a changed focal position. Having regard to the optical distortion coefficients, it is true that they are independent from the considered scene, however, these are dependent on the camera parameters. The camera parameters themselves are also independent from the scene, but not from the focal position. For this reason, the cameras 10 having the variable focus distortion parameter for the different focal positions have to be taught and stored in different sets of transformation parameters. This step can be omitted if it should be possible in the future to provide the dependency of distortion parameters with respect to the focal position in a closed form in a camera model. In any event a rectification can be carried out without problems for diverse focal positions in accordance with the invention, as the transformation parameters have merely got to be pre-calculated and stored and no complete lookup tables have to be calculated and stored in advance, as is currently the case and which is practically nearly impossible and in any event very demanding in effort and cost. Having regard to the transformation unit 24 in accordance with the invention it practically plays no role which transformation parameters are true for the pixel currently being processed, the transformation parameter manager 38 must merely access the respective matching transformation parameters.

Rather than switching between transformation parameters for different image regions one can also consider rectifying an image sequence a plurality of times and in particular in parallel with different transformation parameters. Thereby views from different perspectives become possible and even stereo methods having a camera system are plausible.

For reasons of completeness a few cases of application will now be presented. FIG. 13 shows the recording of a package at whose side surfaces codes are attached. This task is present in numerous applications, since rectangular shaped optics are frequently present without it being determined in advance, at which surfaces the codes could be present. With the aid of the invention it is possible to define the different side surfaces as individual ROIs and to rectify these with different sets of transformation parameters. The required transformation parameters are, for example, obtained from a taught position of the camera 10 and from predefined, taught information on the package geometry or from information on the package geometry determined by means of a geometric detection sensor. The rectified result image shows the two side surfaces in a vertical perspective which can be placed directly stitched next to one another due to the same image resolution achieved at the same time due to the transformation. Without further ado it is clear that subsequent image evaluations such as the decoding or a text recognition with the rectified image result in better results in a more simple manner than with the source image.

FIG. 14 shows a further example in which a plurality of cameras are mounted adjacent to one another and in a partly overlapping manner and in a partly complementing manner record a surface of a package. The rectification in accordance with the invention ensures that each of the cameras provides a rectified image having the same resolution in particular, if possible, also purified from different distortions. The rectified individual images can subsequently be stitched to a complete image of the package surface. In accordance with the same principle, also a larger number of camera heads can be connected in order to generate an even wider reading field. Such a modular design is again significantly more cost-effective than an individual camera having optics demanding in effort and cost, wherein an objective having a practically unlimited wide reading field could not be achieved independent of the cost question.

It is also possible to combine the ideas illustrated in FIGS. 13 and 14, this means to use a plurality of cameras and to evaluate a plurality of ROIs for at least one of the cameras.

FIG. 15 shows a variation of a multiple arrangement of cameras which do not lie next to one another in this example, but rather have been arranged about an exemplary cylindrical object. With the aid of suitable transformation parameters the respective part view of the cylinder jacket can be rectified and can subsequently be stitched to a total image.

What is claimed is:

1. An optoelectronic apparatus for the recording of rectified images, comprising an image sensor which records a source image from a monitored zone and comprising a digital component which processes the source image, wherein transformation parameters for rectifying the source image are stored in the digital component and wherein a transformation unit is implemented at the digital component which dynamically calculates a rectified image from the source image with reference to the transformation parameters.

2. The optoelectronic apparatus in accordance with claim 1,
wherein the optoelectronic apparatus is a camera-based code reader.

3. The optoelectronic apparatus in accordance with claim 1,
wherein the digital component is an FPGA.

4. The optoelectronic apparatus in accordance with claim 1,
wherein the transformation parameters comprise parameters for a perspective correction and/or a distortion correction.

5. The optoelectronic apparatus in accordance with claim 4,
wherein the transformation parameters for the perspective correction comprise a rotation, a translation, an image width and/or a shift of the image sensor with respect to the optical axis.

6. The optoelectronic apparatus in accordance with claim 4,
wherein the transformation parameters for the distortion correction comprise at least the first and the second radial distortion coefficients.

7. The optoelectronic apparatus in accordance with claim 1,
further comprising a calibration unit in order to determine the transformation parameters with reference to a recorded calibration target.

8. The optoelectronic apparatus in accordance with claim 1,
wherein the transformation parameters can be changed between two recordings of the image sensor.

9. The optoelectronic apparatus in accordance with claim 1,
further comprising an objective having a focus adjustment and wherein, following a focus adjustment, the transformation unit uses transformation parameters matched thereto.

10. The optoelectronic apparatus in accordance with claim 1,
wherein the transformation parameters can be changed within the rectification of the same source image.

11. The optoelectronic apparatus in accordance with claim 1,
wherein the transformation unit uses different transformation parameters within the source image for a plurality of regions of interest.

12. The optoelectronic apparatus in accordance with claim 1,
wherein the transformation parameters can be changed in that a plurality of sets of transformation parameters are stored in the digital component and a change is made between these sets.

13. The optoelectronic apparatus in accordance with claim 1,
wherein the transformation unit interpolates one image point of the rectified image from a plurality of adjacent image points of the source image.

14. The optoelectronic apparatus in accordance with claim 1,
wherein the transformation unit uses floating point calculations in a DSP core of the digital component configured as an FPGA for an accelerated real time rectification.

15. The optoelectronic apparatus in accordance with claim 1,
wherein the transformation unit has a pipeline structure which outputs image points of the rectified image.

16. The optoelectronic apparatus in accordance with claim 15,
wherein the transformation unit outputs image points of the rectified image in time with the reading of image points of the source image from the image sensor.

17. The optoelectronic apparatus in accordance with claim 1,
further comprising a plurality of image sensors which each generate a source image from which the transformation unit calculates a rectified image, wherein an image stitching unit is configured to stitch the rectified images to a common image.

18. A method for the recording of rectified images in which a source image is recorded from a monitored zone and is processed with a digital component, the method comprising the step of
dynamically calculating a rectification on the basis of stored transformation parameters at a transformation unit implemented at the digital component in order to transform the source image into a rectified image.

19. The method in accordance with claim 18,
wherein the digital component is an FPGA.
